(19) United States
(12) Patent Application Publication
(10) Pub. No.: US 2008/0035075 A1
(43) Pub. Date: Feb. 14, 2008

(54) DEVICE FOR REDUCING INSECT IRRITATION

(75) Inventor: Elke Schlosser, Menlo Park, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Bug Brow, Inc., South San Francisco, CA (US)

(21) Appl. No.: 11/840,002

(22) Filed: Aug. 16, 2007

Related U.S. Application Data
(63) Continuation-in-part of application No. PCT/US07/17891, filed on Aug. 13, 2007.
(60) Provisional application No. 60/822,223, filed on Aug. 11, 2006.

(51) Int. Cl. A01K 13/00

(52) U.S. Cl. 119/850

(57) ABSTRACT

The invention is a barrier preventing insects from irritating the eyes and face of animals by means of a band embedded with hair or synthetic hair which is stretched across the animals' forehead creating a removable browband and attached to a bridle, halter, cap or similar device, thus creating a form of wig for the animal's naturally occurring forelock. It enhances insect protection creating a formidable barrier by increasing the length, thickness and amount of hair that would normally occur on an animal with a forelock, such as a horse. It could be adapted for use by a variety of animals with or without a naturally occurring forelock. Its light weight allows the barrier to set over the eyes and face without moving away from the protruding eyes, providing a non-irritating and attractive insect shield. It can be further embellished for decorative purposes.

### CROSS-REFERENCES TO RELATED APPLICATIONS

This application is a continuation-in-part of International Application No. PCT/2007/______ (Attorney Docket No. 026944-000110PC), filed Aug. 13, 2007 which claims benefit under 37 USC 119(e) of U.S. Application No. 60/822,223, filed Aug. 11, 2006, both of which are incorporated by reference in their entirety for all purposes.

### BACKGROUND OF THE INVENTION

Flies and mosquitos and other insects are a common source of irritation to animals such as horses. Irritation caused by insects often occurs around the eyes. Beyond causing annoyance to an animal, the presence of insects around an animals eyes can be a cause of eye infection. Eye infections compromise the health of an animals eyes and in severe cases blindness can occur.

### BRIEF SUMMARY OF THE INVENTION

The invention provides a device for reducing insect irritation of an animal. In one aspect, the device comprises a support having an upper side, a lower side, a first end, and a second end; and a plurality of filaments, wherein the support is configured to removably attach to at least a browband or the cheek pieces of a head stall. In some such aspects, the plurality of filaments extend from the lower edge of the support.

In another aspect of the invention, the support attaches to the browband of a bridle. In some devices, the upper side of the support is configured to removably attach to the browband. In some devices, the lower side of the support is configured to removably attach to the browband. In some devices, the upper side of the support is configured to removably attach to the browband. In another aspect, both lower side and the upper side of the support is configured to removably attach to the browband.

In another aspect of the invention the support attaches to the cheek pieces of a head stall. In some devices, the support comprises a strap at each end configured to attach to the cheek pieces.

In some devices, the strap comprises a front side and a back side, wherein an attachment structure affixed to the front side to removably attach the front side to the back side of the strap, and wherein an attachment structure affixed to the backside to removably attach the back side to a front side of the strap. In other devices, the attachment structure affixed to the front side is a piece of fabric of small hooks that sticks to a corresponding fabric of small loops and the attachment structure affixed to the back side is the corresponding fabric of small loops. In other devices, the attachment structure affixed to the backside is a piece of fabric of small hooks that sticks to a corresponding fabric of small loops and the attachment structure affixed to the front side is the corresponding fabric of small loops. In another aspect, the attachment structure affixed to the front side is a button and the attachment structure affixed to the back side is a button hole. In yet another aspect, the attachment structure affixed to the front side is a snap and the attachment structure affixed to the back side is a corresponding snap closure. In some aspects, the attachment structure affixed to the front side is affixed by stitching, heat sealing or adhesive. In some aspects, the attachment structure affixed to the back side is affixed by stitching, heat sealing or adhesive.

The invention also provides, the upper side is affixed to the lower side to form a pocket to removably receive the browband. In some devices, the upper side is affixed to the lower side by stitching, heat sealing, or adhesive.

The invention further provides a device for reducing insect irritation of an animal, the device comprising a removable cap comprising a first strap having an upper side, a lower side, a first end and a second end, wherein the first end and the second end are configured to removably attach around an animal's throat latch; a support having an upper side, a lower side, a first end, and a second end, wherein the first end and the second end are attached to the lower side of the first strap; a second strap having a first end and a second end, wherein the first end is attached to the lower side of the first strap and the second end attached to the upper side of the support; a third strap having a first end and a second end, wherein the first end is attached to the lower side of the first strap and the second end is attached to the upper side of the support; wherein the support is configured to fit across the animal's forehead and the second and third strap fit over the animal's poll and are attached to the first strap and support so they fit between the animal's ears and, a plurality of filaments. In some aspects of the invention, the plurality of filaments extend from the lower edge of the support. In some aspects the first strap comprises a front side and a back side, wherein an attachment structure affixed to the front side of the first end to removably attach the front side of the first end to the back side of the second end, and wherein an attachment structure affixed to the backside of the second end to removably attach the back side of the second end to the front side of the first end.

In some devices, the plurality filaments is comprised of synthetic hair. In some devices, the plurality of filaments is selected from the group consisting of polyamide, polyester, polyethylene and polyvinyl chloride filaments. In other aspects, the plurality of filaments is selected from the group consisting of TAKLON, TEIJIN and TYNEX. In other aspects, the plurality of filaments of comprised of horse hair.

In some devices, the support is comprised of pliable material selected from the group consisting of fleece, synthetic fleece, fabric, imitation leather, BIOTHANE, ultra suede, polyester webbing, webbing, rubber, GORTEX, vinyl, elastic tape and leather. In other aspects of the inventions, the support, first strap, and strap and/or the third strap are comprised of pliable material selected from the group consisting of fleece, synthetic fleece, fabric, imitation leather, BIOTHANE, ultra suede, polyester webbing, webbing, rubber, GORTEX, vinyl, elastic tape and leather.

In some devices, the plurality of filaments is affixed to the support by at least one double sided adhesive strip, by at least one single sided adhesive strip or by adhesive. In some devices, the adhesive is glue or heat activated adhesive. In some devices, the plurality of filaments is further affixed to the support by stitching or heat sealing. In some such devices, a pliable material is embedded with the plurality of filaments.

### BRIEF DESCRIPTION OF THE DRAWINGS

FIG. 1 is a side perspective view of the invention, illustrating the invention attached to a halter by means of 2 Velcro (or similar material) straps. Other methods of attachment are available but Velcro (or similar) straps are preferable due to their ease of application and removal.

FIG. 2 is a close up side perspective of the invention illustrating the invention attached to a halter by means of 2 Velcro (or similar material) straps. Other methods of attachment are available but Velcro (or similar) straps are preferable due to their ease of application and removal.

FIG. 3 is a front side perspective of the invention illustrating the band embedded with hair or synthetic hair and the attached Velcro (or similar material) straps. Other methods of attachment are available but Velcro (or similar) straps are preferable due to their ease of application and removal.

FIG. 4 is a side perspective view illustrating the invention attached by means of a seam to a removable cap.

FIG. 5 is a side perspective view illustrating the invention attached to an existing browband by means of Velcro (or similar material) straps. Other methods of attachment are available but Velcro (or similar) straps are preferable due to their ease of application and removal.

FIG. 6 is a front perspective view of the invention attached by means of a seam to a removable cap.

### DETAILED DESCRIPTION OF THE INVENTION

The present invention relates to a device for reducing issect irritation, a hair browband, which addresses the recurrent problem of insect irritation to the eyes and face of an animal. One of the things that makes this invention unique is the use of filaments which is a more effective method of insect barrier than current methods and which has not been employed in this manner. Hair is a preferred filament. The term “hair” is used to include natural hair or synthetic hair. Natural hair includes horse hair. Horse hair is a most preferred filament. Synthetic hair may be in the form of polyamide, polyester, polyethylene or polyvinyl chloride filaments or monofilaments. Synthetic hair may be a combination of different filaments or monofilaments. For example, polyester and polyethylene filaments or monofilaments. Synthetic hair includes TORAY, TAKLON, TEIJIN OR TYNEX.

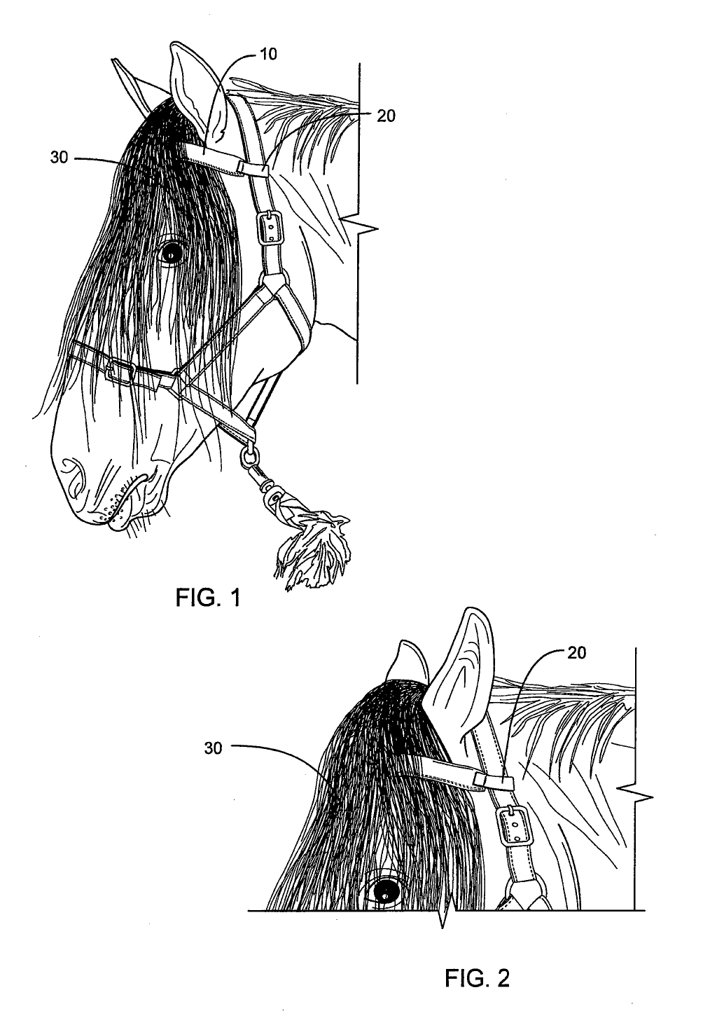

The device is comprised of the following components: A support embedded with hair or synthetic hair is placed across the animals forehead and attached to a bridle, halter or cap (FIGS. 1, 4, & 5), creating a type of wig for the animal's naturally occurring forelock. It enhances insect protection by providing a more formidable barrier than what Nature already provides around the eyes and face of the animal. It does so by increasing the length and amount of hair that would normally occur on an animal with a forelock (such as a horse) providing a natural and attractive alternative to other products such as “fly masks”, “fly strings”, or “fly fringe”. Unlike currently available solutions, its light weight allows it to properly cover the eye area without falling off to the sides of the protruding eyes. Currently available solutions such as “fly strings” do not create adequate protection because their weight tends to cause the barrier to move to either side and away from the protruding eyes rendering them ineffective. Currently available solutions to fly barriers do not employ the use of hair or synthetic hair. Currently available products such as “fly masks” inhibit the animals' eye site, are unattractive and irritate the animal. Furthermore, currently available solutions such as “fly masks” can on occasion actually trap insects under the mask exacerbating the problem of insect irritation. Currently available products are not as attractive.

The present invention solves the aforementioned difficulties and is superior to current methods due to the following elements:
The present inventions' light weight allows it to set over the animals' eyes and face without falling to either side of the protruding eyes.
The present invention does not trap insects under the barrier which can cause irritation to the animal.
The present invention is far more attractive allowing for more versatility of use in competitions and while riding, driving or any other activity.
The present invention does not impede the animals' eye site.
The present invention is not irritating to animals.

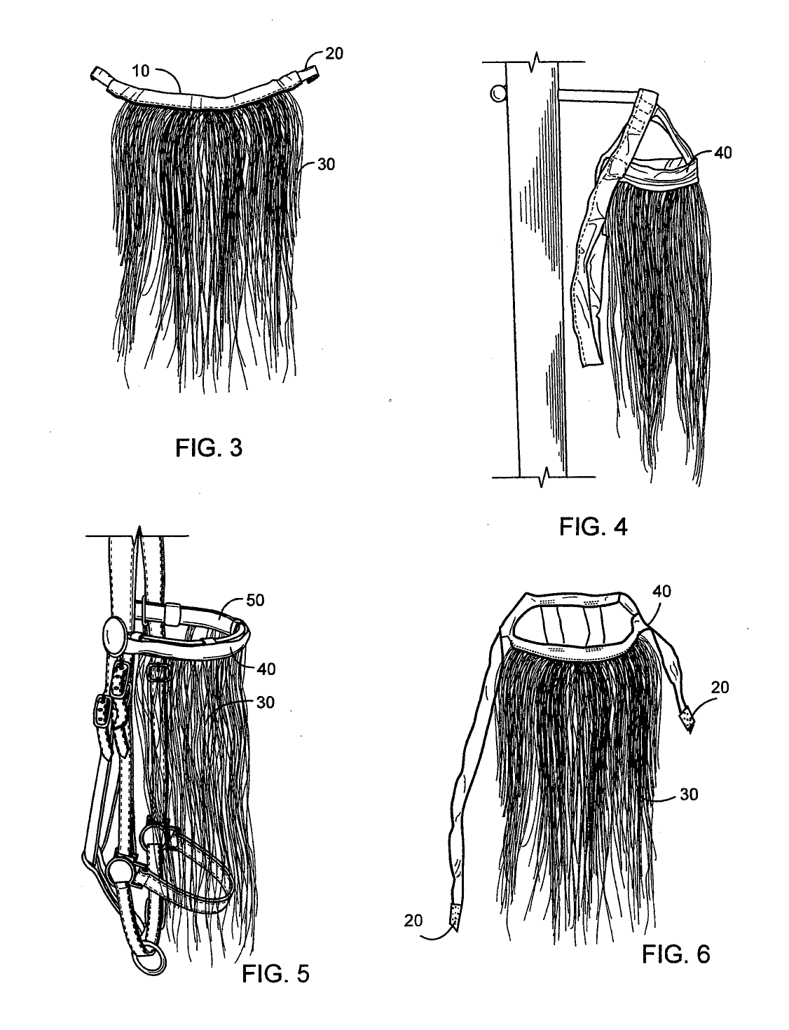

The best and most complete way to make the present invention is by creating a support, or browband, made of a strip of pliable material (FIG. 3) which is the basis of this product. Ribbon is the preferred material due to its durability, softness, wash-ability and the variety of colors available. Alternatively it could be made of any soft pliable material such as fleece, synthetic fleece, fabric, imitation leather, BIOTHANE, ultra suede, polyester webbing, webbing, rubber, GORTEX, vinyl, elastic tape, leather or similar pliable material.

A closure consisting of a piece of fabric of small hooks that sticks to a corresponding fabric of small loops, for example, VELCRO straps of varying lengths are attached by means of stitching at various intervals for the purpose of attaching the invention to the bridle or halter (FIGS. 1-20, 2-20, 3-20 & 5). Velcro (or similar) straps are the preferred method of attaching the invention due to their ease of placement and removal. Instead of Velcro (or similar material), grommets, snaps, ribbon ties, fabric ties, string ties, coated wire ties, wire ties, wire, tape, buttons, zippers, twine, leather, interlocking clips, clips, elastic or similar materials could be used less effectively to hold the invention in place. Alternately, the Velcro (or similar material) itself could also be attached by other means such as an adhesive. Alternately a sewn, heat sealed or glued pocket could be created to hold the invention in place. The invention could be adapted to be used without a bridle or halter by means of a cap made of a pliable material which consists of the aforementioned hair browband that is attached to another band of pliable material which extends over the animals poll and attaches under or beside the throat. Two additional straps of pliable material extend from the browband to the poll between the ears. These straps secure proper placement of the cap on the animals head by utilizing the animals existing forelock which is pulled through the opening between the two straps (FIG. 4). A seam or seal is employed attaching the band to the cap (FIGS. 6-40).

Double sided adhesive strips are applied to the surface of the band to hold the hair in place. Alternately, a glue or heat activated adhesive could be utilized.

Hair or synthetic hair (such as polyester filaments, Toray, Taklon, Teijin, Tynex or similar products) is placed over the adhesive covered area. This is done in several layers of adhesive covered with hair to create sufficient fullness of the hair.

The pliable material embedded with the hair is seamed and/or sealed to finally secure the hair.

Decorative accents may be used to embellish the present invention. These include but are not be limited to adornments such as sequins, crystals, conchos, metal or metallic adornments, hitched horse hair, rawhide or leather, decorative stitching or other attachments.

The components work together accordingly:
(1) A band or strap is made using pliable material as the vehicle for distributing and holding the hair or synthetic hair in place creating a brow band (FIG. 3).
(2) Velcro (or similar material) straps attach the band to the halter or bridle. Alternately a pocket could be created to hold the invention in place (FIGS. 1, 2, 3 & 5). The band could also be attached to a cap (FIGS. 4 & 6) thereby eliminating the need for a bridle or halter. The cap is made of a pliable material which consists of the aforementioned hair browband that is attached to another band of pliable material which extends over the animals poll and attaches under or beside the throat. Two additional straps of pliable material extend from the browband to the poll between the ears, further securing the proper placement of the cap on the animals head by utilizing the animals existing forelock which is pulled through the opening between the two straps (FIG. 4).
(3) Adhesive is used to hold the hair in place on the band until it is secured. Hair or synthetic hair (artificial material) is used as a “wig” to enhance the animals natural forelock
(4) Securing the seam by means of sewing, gluing, laminating or heat sealing the band finishes the article and secures the hair permanently in place.
(5) Additionally decorative embellishments may be added if desired.

This present invention provides insect protection around the face of a variety of animals, including livestock, that may be fitted with the device. Animals that may be fitted with the device include horses, mules, ponies, cows, and sheep. Many animals have a naturally occurring “forelock” which is the best solution to insect irritation around the animals face. However many animals do not have a forelock of sufficient length and density to adequately protect them from facial insects. The present invention creates a forelock “wig” of sufficient size and scope to protect the animal from facial insects. The “wig” is held in place by securing it to a bridle, halter or cap (FIGS. 1, 2, 4, 5, & 6).

The band could be made in different widths, lengths, colors and sizes as needed. It could also be embellished with decorative accents. The band could be made of any pliable material (as previously mentioned) into which the hair or synthetic hair is secured, and by repositioning the fasteners (FIGS. 1,2 & 3), be used without attaching it to an existing browband. In that way it could be attached to a halter or bridle that does not have a browband. Alternately, the band could be attached to a cap (illustrated in FIG. 4 and FIG. 6) which would take the place of either a halter or bridle. Alternatively, the band could be secured by other means depending on the shape of the particular animals head. While the present invention has been described in terms of specific embodiments, it is to be understood that the invention is not limited to these disclosed embodiments. This invention may be embodied in many different forms and should not be construed as limited to the embodiments set forth herein; rather, these embodiments are provided by way of illustration only and so that this disclosure will be thorough, complete and will fully convey the full scope of the invention to those skilled in the art. Indeed, many modifications and other embodiments of the invention will come to mind of those skilled in the art to which this invention pertains, and which are intended to be and are covered by both this disclosure, the drawings and the claims.

1. A device for reducing insect irritation of an animal, the device comprising
a support having an upper side, a lower side, a first end, and a second end;
and
a plurality of filaments,
wherein the support is configured to removably attach to at least a browband of a bridle or the cheek pieces of a head stall.

2. The device of claim 1, wherein the plurality of filaments extend from the lower edge of the support.

3. The device of claim 1, wherein the upper side of the support is configured to removably attach to the browband.

4. The device of claim 3, wherein the lower side of the support is configured to removably attach to the browband.

5. (canceled)

6. The device of claim 3, wherein the support comprises at least one strap at the upper side configured to attach to the browband.

7. The device of claim 4, wherein the support comprises at least one strap at the lower side configured to attach to the browband.

8. (canceled)

9. The device of claim 1, wherein the support comprises a strap at each end configured to attach to the check pieces.

10. The device of claim 6, wherein the strap comprises a front side and a back side,
wherein an attachment structure affixed to the front side to removably attach the front side to the back side of the strap, and
wherein an attachment structure affixed to the backside to removably attach the back side to a front side of the strap.

11. The device of claim 10, wherein the attachment structure affixed to the front side is a piece of fabric of small hooks that sticks to a corresponding fabric of small loops and the attachment structure affixed to the back side is the corresponding fabric of small loops;
wherein the attachment structure affixed to the front side is a button and the attachment structure affixed to the back side is a button hole;
wherein the attachment structure affixed to the front side is a snap and the attachment structure affixed to the back side is a corresponding snap closure; or
wherein the attachment structure affixed to the front side is affixed by stitching heat sealing or adhesive.

12. The device of claim 10, wherein the attachment structure affixed to the backside is a piece of fabric of small hooks that sticks to a corresponding fabric of small loops and the attachment structure affixed to the front side is the corresponding fabric of small loops.

13-14. (canceled)

15. The device of claim 10, wherein the attachment structure affixed to the front side is affixed by stitching, heat sealing or adhesive or the attachment structure affixed to the back side is affixed by stitching heat sealing or adhesive.

16. (canceled)

17. The device of claim 4, wherein the upper side is affixed to the lower side to form a pocket to removably receive the browband.

18. The device of claim 17, wherein the upper side is affixed to the lower side by stitching, heat sealing, or adhesive.

19. The device of claim 1, wherein the plurality filaments is comprised of synthetic hair or horse hair.

20. The device of claim 19, wherein the plurality of filaments is synthetic hair selected from the group consisting of polyamide, polyester, polyethylene and polyvinyl chloride filaments.

21. The device of claim 19, wherein the plurality of filaments is selected from the group consisting of TAKLON, TEIJIN and TYNEX.

22. (canceled)

23. The device of claim 1, wherein the support is comprised of pliable material selected from the group consisting of fleece, synthetic fleece, fabric, imitation leather, BIOTHANE, ultra suede, polyester webbing, webbing, rubber, GORTEX, vinyl, elastic tape and leather.

24. The device of claim 2, wherein the plurality of filaments is affixed to the support by at least one double sided adhesive strip, by at least one single sided adhesive strip or by adhesive.

25. (canceled)

26. The device of claim 24, wherein the plurality of filaments is further affixed to the support by stitching or heat sealing.

27. The device of claim 24, wherein a pliable material is embedded with the plurality of filaments.

28. A device for reducing insect irritation of an animal, the device comprising
a removable cap comprising
a first strap having an upper side, a lower side, a first end and a second end, wherein the first end and the second end are configured to removably attach around an animal's throat latch;
a support having an upper side, a lower side, a first end, and a second end, wherein the first end and the second end are attached to the lower side of the first strap;
a second strap having a first end and a second end, wherein the first end is attached to the lower side of the first strap and the second end attached to the upper side of the support;
a third strap having a first end and a second end, wherein the first end is attached to the lower side of the first strap and the second end is attached to the upper side of the support;
wherein the support is configured to fit across the animal's forehead and the second and third strap fit over the animal's poll and are attached to the first strap and support so they fit between the animal's ears;
and,
a plurality of filaments.

29-48. (canceled)

49. The device of claim 7, wherein the strap comprises a front side and a back side,
wherein an attachment structure affixed to the front side to removably attach the front side to the back side of the strap, and
wherein an attachment structure affixed to the backside to removably attach the back side to a front side of the strap.

50. The device of claim 49, wherein the attachment structure affixed to the front side is a piece of fabric of small hooks that sticks to a corresponding fabric of small loops and the attachment structure affixed to the back side is the corresponding fabric of small loops;
wherein the attachment structure affixed to the front side is a button and the attachment structure affixed to the back side is a button hole;
wherein the attachment structure affixed to the front side is a snap and the attachment structure affixed to the back side is a corresponding snap closure; or
wherein the attachment structure affixed to the front side is affixed by stitching, heat sealing or adhesive.

51. The device of claim 49, wherein the attachment structure affixed to the backside is a piece of fabric of small hooks that sticks to a corresponding fabric of small loops and the attachment structure affixed to the front side is the corresponding fabric of small loops.

52. The device of claim 49, wherein the attachment structure affixed to the front side is affixed by stitching, heat sealing or adhesive or the attachment structure affixed to the back side is affixed by stitching heat sealing or adhesive.
